(19) United States
(12) Patent Application Publication
(10) Pub. No.: US 2003/0170156 A1
(43) Pub. Date: Sep. 11, 2003

(54) Apparatus for mixing acid and base

(75) Inventors: Maurice Clarence Kemp, El Dorado Hills, CA (US); Robert H. Carpenter, Bastrop, TX (US); Robert Blaine Lalum, Citrus Heights, CA (US); Gregory L. Townsend, Plymouth, MN (US); Thomas G. Dandurand, Plymouth, MN (US); William W. Norman, Minneapolis, MN (US); Bob A. Palme, Lindstrom, MN (US); Judy Rae Dandurand, St. Cloud, MN (US)

Correspondence Address: JACKSON WALKER LLP, 2435 NORTH CENTRAL EXPRESSWAY, SUITE 600, RICHARDSON, TX, 75080, US

(73) Assignee: Mionix Corp., Roseville, CA (US)

(21) Appl. No.: 10/092,956

(22) Filed: Mar. 7, 2002

(51) Int. Cl. B01F 3/00; B01F 5/00; F28D 1/00; G05D 23/00

(52) U.S. Cl. 422/224; 366/145; 366/152.2; 366/165.1; 366/142; 422/198; 422/109; 422/110; 366/136; 366/175.2

(57) ABSTRACT

The present invention pertains to an apparatus for mixing mineral acid (e.g. sulfuric acid), and hydroxide bases (e.g. calcium hydroxide) to produce various useful mixtures (e.g. cleaning products, food production, etc.). The present invention provides an apparatus for reproducibly injecting an acid and a base to form a mixture in a controlled environment. In one aspect, the apparatus comprises a chamber having a distribution-blending-cooling dish suspended above the mixing chamber, an acid delivery system for introducing diluted acid into the chamber above the distribution-blending-cooling dish, and a base delivery system for introducing the base into the chamber by passing the base through the distribution-blending dish. The acid is injected preferentially and circumferenceially to provide, enhance, and cause thorough blending. The injectors or eductors are in the mixing chamber, and the blending dish is secondary to the initial introduction of acid. The mixture is re-circulated out the bottom of the chamber and up to the distribution-blending-cooling dish along with the base.

### BACKGROUND

An acidic solution of sparingly-soluble Group IIA complexes (“AGIIS”) can be prepared by mixing a mineral acid (e.g. sulfuric acid), and a Group IIA hydroxide (e.g. calcium hydroxide). The various uses of such a mixture include cleaning products, food production, various decontamination solutions, bioremediation, agricultural application, medical application, and detoxification of substances or surfaces.

To produce large quantities of such versatile compounds, acid and base chemicals can be mixed together within a vented reaction chamber cannot be enclosed, it will blow up like a big bomb if it is not vented. However, the extreme exothermic reaction produces excessive heat within the chamber. Because heat can catalyze undesirable side reactions within any given mixture, it is of critical importance that the temperature of a mixing chamber should be controlled precisely. For example, in acid/base mixtures, the excessive heat may be so large that the mixture is uncontrollable and certainly irreproducible from one batch to another. There are few methods that can be employed to regulate the temperature in a reaction chamber. For example, a heat transfer system may be used to govern the rapidly changing temperature within the chamber. Conventionally, heating and cooling jackets, such as those connected to a heat exchanger have been used to control the temperature of the reaction chamber. Additionally, regulating the introduction rate of chemicals (e.g. the acid) into the chamber can be utilized to moderate increased temperature within the chamber.

Thus, by controlling the temperature of water via a cooling jacket, and mixing method and controlling the rate (i.e. velocity and volume) of the acid “injected” into the cold water, exothermic reactions can be well regulated and products produced reproducibly. Although acid and water can be mixed manually, it is uneconomical, inappropriate and hazardous to conduct such a task manually. Accordingly, what is needed in the art is an apparatus and method for blending an acid and a base to form a mixture that is generally effective and that overcomes the irreproducibility deficiencies of the prior art.

The present invention is generally directed to a mixing apparatus and method for mixing an acid and a base under controlled conditions. This invention can mix chemicals at a high rate and high volume without overheating the reaction mixture achieving a thoroughly mixed and consistent mixture. Thus, the overarching benefit of the current invention is in the cost benefit for mass-producing accurate chemical constituents.

### SUMMARY

The present invention pertains to an apparatus for mixing acids and bases. Various useful mixtures can be prepared by mixing a mineral acid (e.g. sulfuric acid), and a base (e.g. calcium hydroxide). For example, such useful mixtures include: cleaning products, food production, various decontamination solutions, bioremediation, agricultural application, medical application, and detoxification of substances or surfaces.

One embodiment of the present invention relates to an apparatus for blending an acid and a base to form a mixture. The apparatus comprises a chamber having a distribution-blending-cooling dish suspended therein, an acid delivery system for introducing the acid into the chamber and to the distribution-blending-cooling dish, and a base delivery system for introducing the base into the chamber via the distribution-blending-cooling dish. The apparatus allows an acid (e.g. sulfuric acid) and a base (e.g. calcium hydroxide in the form of a slurry) the calcium hydroxide could be sprayed, dry, into the dish as in the method used to spray powdered paint or to spray powdered metal to be sprayed into the chamber to utilize in-air mixing. The acid/base spray that does not mix in-air forms a thin layer on the distribution-blending-cooling dish. The distribution-blending-cooling dish is of an adequate size and shape to allow broad distribution of the acid/base components. Additional in situ mixing occurs within the chamber below the distribution-blending-cooling dish. The in situ mixing occurs via a vortex generator that is described in a preferred embodiment of the invention. Additional features of the preferred apparatus include a non-corrosive compound (e.g. ethyl tetraflouro ethylene which is a fluor-polymer as in DuPont's Teflon™, which is tetrafluoroethylene, a fluorocarbon polymers, or fluorinated ethylene-propylene) coating on the inside surface of the chamber and on the surface of the distribution-blending-cooling dish and on all chemical contacting surfaces.

Because of the exothermic nature of the acid/base reaction, another preferred embodiment of the apparatus further comprises a chamber cooling coil, coupled to the chamber, which operates to lower a temperature of the chamber. The invention further comprises a chamber temperature sensor that is coupled to the chamber, which can sense the temperature of the chamber and regulate the cooling coil and therefore the chamber temperature. The distribution-blending-cooling dish is also coupled to a cooling coil with a dish temperature sensor that can regulate the temperature of its coil and therefore the distribution-blending-cooling dish.

One preferred embodiment of the invention includes an acid delivery system that comprises an acid pump, and an acid delivery nozzle, wherein the acid pump and the acid delivery nozzle are coupled thereto to introduce the acid into the chamber in a preferred geometric location to enhance mixing and temperature control. The acid delivery system also comprises an acid reservoir that contains the acid. This acid reservoir contains a cooling coil that operates to lower a temperature of the acid in the reservoir. The preferred acid delivery system is capable of regulating a rate of flow and an amount of the acid sprayed into the chamber. A base delivery system is also disclosed and comprises a base reservoir, a cooling coil, and the capability to regulate the flow rate of base sprayed into the mixing dish.

Although the acid and base delivery systems comprises mechanisms for in-air mixing, which diminishes hard particles (e.g. un-reacted base or encapsulated hydroxide) from appearing in the resultant mixture, suspensions with hard particles still appear in the blended mixture. Thus, the acid delivery system further comprises a vortex generator that generates a vortex in the diluted acid in the chamber below the distribution-blending-cooling dish. The vortex generator helps blend the hard particles by mixing the acid and base in a vortex and regulating the amount of air that incorporates into the mixture. The vortex generator pump can actually crush the residual hard particles, which increases blending of the acid and base. Also a tubular mixing apparatus can be used for this invention, in which a high pressure ventura forces hard particles to collide with each other and against sharp shearing edges of the apparatus to eliminate all hard particles larger than any individual solid constituent of the mixture. Furthermore, if one allows a vortex to be present during delivery of the base slurry, the air passing through the vortex will disrupt the rate of delivery and corrupt calculations. Therefore, the plumbing circuit and control scheme does not allow air into the delivery pump until the base slurry is delivered. Thus, in an embodiment of the present invention the acid is injected preferentially and circumferenceially to cause thorough blending. The injectors are in the mixing tank. The blending dish is secondary to the initial introduction of acid. The mixture is pumped out the bottom and up to the dish along with the base.

Another embodiment of the current invention includes the apparatus further comprising a precipitate chamber, wherein the mixture is allowed to precipitate. A filter chamber that filters the mixture is also contemplated by this invention. Furthermore, a storage chamber that stores the mixture is also disclosed as an embodiment of the invention.

### BRIEF DESCRIPTION OF THE DRAWING

For a more complete understanding of the present invention, reference is now made to the following description taken in conjunction with the accompanying drawing, wherein:

FIG. 1 illustrates one embodiment of an apparatus of the present invention for mixing an acid and a base.

### DETAILED DESCRIPTION

The present invention pertains to an apparatus for mixing acids and bases. Various useful mixtures can be prepared by mixing a mineral acid (e.g. sulfuric acid), and a base (e.g. calcium hydroxide). For example, such useful mixtures include: cleaning products, food production, various decontamination solutions, bioremediation, agricultural application, medical application, and detoxification of substances or surfaces.

To produce large quantities of such versatile compounds, acid and base chemicals can be mixed together within a reaction chamber. However, the extreme exothermic reaction produces excessive heat within the chamber. Because heat can catalyze undesirable side reactions within any given mixture, it is of critical importance that the temperature of a mixing chamber should be controlled precisely. For example, in acid/base mixtures, the excessive heat may be so large that the mixture is uncontrollable and certainly irreproducible from one batch to another. There are few methods that can be employed to regulate the temperature in a reaction chamber. For example, a heat transfer system may be used to govern the rapidly changing temperature within the chamber. Conventionally, heating and cooling jackets, such as those connected to a heat exchanger have been used to control the temperature of the reaction chamber. Additionally, regulating the introduction rate of chemicals (e.g. the acid) into the chamber can be utilized to moderate increased temperature within the chamber.

To address the above-discussed deficiencies of the prior art, the present invention provides an apparatus and a method for reproducibly injecting an acid and a base to form a mixture in a controlled environment. In one aspect, the apparatus comprises a chamber having a distribution-blending-cooling dish suspended above the mixing chamber, an acid delivery system for introducing diluted acid into the chamber above the distribution-blending dish, and a base delivery system for introducing the base into the chamber by passing through the distribution-blending dish. The introduction of acid and base comprises in-air mixing above the distribution-blending dish. One major reason for the midair mixing is to dissipate heat from the solution. The more heat removed at this point, the better the cooling jacket will function. A thin stream of fluid will give up heat during the exothermic reaction better then a heavy stream. The acid and base will then fall to form a thin layer of acid/base on the distribution-blending dish. The mixture will then undergo in situ mixing within the chamber below the distribution-blending dish. Initial introduction of base therefore meets the acid mixture at a prescribed concentration. After the base is introduced to the acid in mid air and passes over the prescribed concentration of acid flowing across the dish, it falls into the mixing chamber and is recycled to the delivery nozzles above the dish while being recycled over the dish bath; hence, as more base is introduced, the solution changes. In this manner, the apparatus can also control the rate of base going into the mixing system. Again, a thin flat layer of fluid will allow an atom by atom mixing of the base. This thin layer is important. If the base is introduced to fast, it will cause lumps, chunks, and small to large bound together particles. The base will adhere to itself and refuse to become thoroughly mixed causing a bad batch. It can become adhered to the sidewalls of the dish if not introduced at a controlled rate and also gets caught in small cracks.

In another aspect, the present invention provides a method of blending an acid and a base to form a mixture. The method comprises introducing a predetermined acid concentration into a chamber, and then to the apparatus above the mixing chamber referred to as a distribution-blending dish suspended above the mixing chamber. Next, the introduction of the base into the chamber via the distribution-blending dish. The first blending the acid and the base occur in the air above the distribution-blending-cooling dish to give a first mixture. Blending the first mixture in a thin layer of predetermined acid concentration on the distribution-blending dish to give a second mixture, and blending the second mixture in situ within the mixing chamber below the dish. This progressive introduction and blending of the elements therefore controls the chemistry to a point whereby the outcome is predictable.

In another aspect, the present invention provides a method of blending an acid and a base to form a mixture in which a predetermined acid concentration is introduced with a base mixture in a chamber. A resultant material is re-circulated with a high shear force pump or a more uniform acid/base blend. Alternatively a diaphragm type pump can be utilized. The machine will employ a mixing tube (e.g. a high turbulence mixing tube) on the discharge of the pump to accommodate a shearing action (e.g. less than an impeller pump) of the lumps, chunks, and particles mentioned earlier.

The foregoing has outlined, rather broadly, preferred and alternative features of the present invention so that those skilled in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the spirit and scope of the invention in its broadest form.

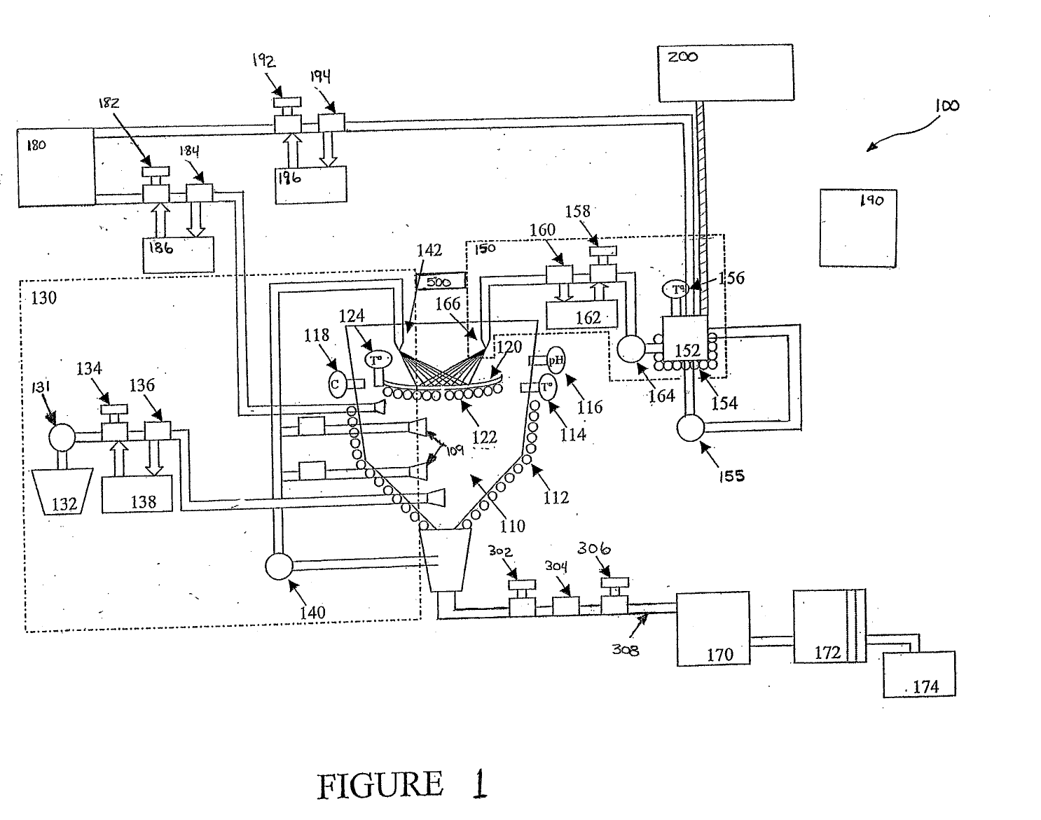

In an embodiment of the present invention, an apparatus for mixing an acid and a base under controlled reproducible conditions is described. The invention may be better understood with reference to FIG. 1, which comprises a representative schematic of some of the embodiments of the invention, but is not intended to limit the invention.

This invention relates to an apparatus for mixing an acid and a base. As shown in FIG. 1, the apparatus 100 is shown as a representative illustration with the components necessary for uniformly blending an acid and a base. The apparatus 100 includes a chamber 110, wherein the acid and base may be progressively blended. Although the shape of the chamber is not critical, the preferred shape of the chamber 110 comprises a cylindrical shape having a concave bottom. The preferred cylindrical shape has practical utility. For example, since the chamber will contain a cooling jacket or coil 112, and will be subjected to hydraulic pressure inside the jacket, a concave bottom will help the chamber to withstand the pressure. In the illustrated embodiment, the chamber 110 has a cooling jacket or coil 112 wrapped around and configured to lower a temperature of the chamber 110. Additionally, in a specific embodiment of the current invention, the mixture of an acid and a base is blended utilizing a vortex generator, wherein the cylindrical shape of the chamber will assist in creating a vortex within the chamber. The vortex generator comprises various circulation injectors 109 that are connected to a pump 140 whereby a rotational direction of the solution through the injectors and within the chamber is initialized to create a vortex. The directional injectors 109 are strategically placed around the chamber and at different elevations. By adjusting the direction of the ports within the chamber, the vortex and rotational speed of the solution can be controlled, which can maximize the thermal exchange of the solution in contact with the cold wall of the chamber 110. As such, one can control the duration of time that a solution is in contact with the cold wall, which is a very important feature for large chambers. Additionally, the injectors 109 can be adjusted to cause a “cross mix” to the rotation that prevents a stagnant column within the chamber from occurring. By directing one or more of the adjustable injectors toward the center outlet at the bottom of the chamber, the control of the vortex is manageable.

In a preferred embodiment, the chamber 110 further comprises a chamber temperature sensor 114 coupled thereto that senses a temperature of the chamber 110. The chamber cooling jacket or coil 112 and the chamber temperature sensor 114 cooperate to regulate the temperature of the chamber 110. However, the chamber-cooling jacket or coil 112 and the chamber temperature sensor 114 are optional and are not required to practice the present invention. Any other means of cooling the chamber would also be acceptable.

Measurement of the pH, conductivity, and other assorted measurements determine the specific characteristics of a mixture. In the present invention, an operator may wish to verify the predicted results or determine the completion of the blending process. Thus, a preferred embodiment of the chamber 110 comprises a pH sensor 116 therein to determine the pH of the mixture within the chamber 110. Additionally, the chamber 110 may also comprise a conductivity sensor 118 therein that determines the conductivity of the mixture within the chamber 110. Other sensors may also be utilized depending on the specification of the mixture. Similarly, sensors may not be needed in particular applications, and can be omitted without limiting the scope of the invention.

One embodiment of the invention includes the apparatus 100 that further comprises a distribution-blending-cooling dish 120 suspended above the chamber 110. The distribution-blending-cooling dish 120 is configured in a concave fashion so that an acid and a base are introduced into the chamber 110 in-mid air on top of the distribution-blending-cooling dish. The resultant mixture will be distributed into a thin film, blend and cool together on the distribution-blending-cooling dish. The thin film of liquid mixture will drain pass the peripheral of the distribution-blending-cooling dish 120 to the bottom of the chamber 110, wherein the progressive blending begins. Optionally, there can be one or more holes in the middle or arranged in a circular pattern around the center hole to allow fluid to fall from the dish at different locations of the distribution-blending-cooling dish 120. The distribution-blending-cooling dish 120 is preferably of a size and shape proportionate to the amounts of acid and base introduced to each other. This allows the distribution-blending-cooling dish 120 to be efficiently cooled while providing a broad surface area for the chemical reaction, but without constraints. Most importantly, distribution-blending-cooling dish prevents the acid from encapsulating the base and subsequent formation of chunks or inadequately blended material. A series of distribution-blending-cooling dishes arranged vertically may be employed to provide more cooling surface area if a highly reactive and highly exothermic product are desired. In the illustrated embodiment, the distribution-blending-cooling dish 120 is cooled by a circulating chilled solution from chamber 110. Cooling of the distribution-blending-cooling dish can be accomplished by the use of a coil 122, cooling plate, or other cooling means. In order to assure consistency and reproducibility, a temperature sensor 124 can be connected to the distribution-blending-cooling dish 120 to sense and maintain an appropriate temperature. However, the dish cooling coil 122 and the dish temperature sensor 124 are optional and are not required to practice the present invention. However, the dish cooling coil 122 and the dish temperature sensor 124 are configured to be capable of cooperation to regulate the temperature of the distribution-blending-cooling dish 120.

The apparatus 100 further includes an acid delivery system 130 for introducing the acid into the chamber 110. The acid delivery system 130 includes an acid reservoir 132 that contains the acid. The acid reservoir 132 is coupled to an acid pump 131 and supplies a flow valve 134 and an acid flow meter 136. Such a pump or pumping mechanism may be of any variety, including peristaltic for example, or it could be an elevated gravity system or a pressurized system. The acid delivery system 130 further comprises an acid flow controller 138 that monitors the acid flow meter 136 and adjusts the acid flow valve 134 to regulate a rate of flow of the acid from the acid reservoir 132 into the chamber 110. In a preferred embodiment, the acid flow controller 138 is capable of maintaining the rate of flow of the acid at a predetermined level, which may be manually or automatically programmed into the acid flow controller 138. The flow controller 138 can be programmed directly or remotely by an operator through other known controllers or processors (e.g. a PC 190 or PLC). A PC 190 includes hardware capable of executing machine-readable instructions, as well as software for executing acts (i.e. typically machine-readable instructions) that produce a desired result. The acid flow controller 138 is further capable of regulating an amount of acid delivered into the chamber 110 by the acid delivery system 130. The operator can program the amount of acid to be delivered, the rate of flow of the acid, or both as may be appropriate in a particular situation using the acid flow controller 138. The acid tanks are equipped with a reservoir containment to prevent acid spills into the surrounding area.

In the illustrated embodiment, the acid delivery system 130 can introduce the acid into different areas of the chamber 110, including below the distribution-blending area 222 or the distribution-blending-cooling dish 120 (discussed below), wherein the acid is diluted with water to give a predetermined result of diluted acid. The distribution-blending area is the area wherein the acid and base sprayers are shown mixing 222. In another embodiment, the distribution-blending-cooling dish 120 is added. The diluted acid can be removed from the chamber 110, forced through a pump 140, returned to the acid spray nozzle or nozzles 142 and sprayed into the distribution-blending area 222 or above the distribution-blending-cooling dish 120. Additionally, the pump 140 can be further adapted to create a vortex in the diluted acid within the chamber 110 to enhance the blending as explained above. The acid is injected into the mix tank via a small nozzle placed strategically above one of the eductors or injectors. This insures a though mixing of the acid and helps control heat. An optional embodiment of the present invention involves one or more injectors or eductors that are pointed at 45 to 90 degrees to the centerline to defuse the vortex.

In at least one embodiment, pump 140 is a high shear force pump that can be utilized to breaking-up material in the acid/base mixture, which may include encapsulated base. Thus, the pump 140 breaks-up the encapsulated material and re-circulates it through the acid spray for further mixing that enables a more uniform final product. Alternatives to the high shear force pump are also contemplated by this invention. For example, the hard particles in the mixture may wear the impeller down during the long-term use of a high shear force pump. Therefore, any means of a pump or a mixing chamber that is capable of breaking up the material is envisioned for use in the current invention.

The apparatus 100 further includes a base delivery system 150 for introducing the base into the chamber 110 via the distribution-blending area 222 or distribution-blending cooling dish 120. The base delivery system 150 includes a base reservoir/metering system 152 that contains the base. In one such embodiment, the base is in powder form and is delivered to the chamber 110 as a powder, which is similar to a powder painting system utilizing a nozzle. In another embodiment, the powdered base is made into a slurry mixture in the base reservoir 152. Specific embodiments of the current invention that contain a slurry mixture are comprised of a predetermined amount of base material that is introduced to the base reservoir 152 and mixed with a predetermined amount of water. The slurry mixture system also includes a pump 155 coupled to the base reservoir that first mixes the base and water and subsequently re-circulates the slurry mixture to keep the non-soluble solids suspended until the slurry is delivered to the chamber 110.

The base material can be introduced to the base reservoir 152 by a loss-in-weight system 200 or similar type system. The loss-in-weight system 200 determines the weight of base contained in a container and when base is removed, for transfer to the base reservoir, a new weight is determined and subtracted from the initially determined weight in which the resultant is the base material weight transferred. Water is delivered to the base reservoir by the water delivery system that includes a water source 180, flow meter 194 and flow control 196. The amount of water delivered can be controlled manually or automatically programmed as described with regard to acid flow control.

Furthermore, if one allows a vortex to be present during delivery of the slurry, the air passing through the vortex will disrupt the rate of delivery and corrupt calculations. Therefore, the plumbing circuit and control scheme should allow no air into the delivery pump until the slurry is delivered. The presence of air in the vortex can be used to trigger an output to a processor or computer whereby events are initiated to manage and control air presence. For example, other events include a pump on/off, rinsing and wash-down cycles for cleaning the slurry system components.

In another illustrated embodiment, the base reservoir 152 is capable of maintaining a base reservoir cooling coil 154 wrapped around or configured inside to lower a temperature of the base reservoir 152. The base reservoir 152 can further include a temperature sensor 156 coupled thereto thereby sensing a temperature of the base reservoir 152. The base reservoir cooling coil 154 and the base reservoir temperature sensor 156 cooperate to regulate the temperature of the base reservoir 152. Of course, the base reservoir cooling coil 154 and the base reservoir temperature sensor 156 are optional and are not required to practice the present invention.

The base reservoir 152, slurry or otherwise, is coupled to a second pump and base flow valve 158 and a base flow meter 160. The base delivery system 150 further comprises an optional base flow controller 162 that monitors the base flow meter 160 and adjusts the base flow valve 158 to regulate a rate of flow of the base from the base reservoir 152 into the chamber 110. In a preferred embodiment, the base flow controller 162 is capable of maintaining the rate of flow of the base at a predetermined level, which may be programmed into the base flow controller 162 by an operator or controlled by a processor. A metering pump may be required if a large ratio of base to dilution exists. A loss-in-weight system may also be employed to control accurate metering. The metering pump is used to increase the speed of the process and make the process more economical. The base flow controller 162 can further regulate an amount of base material delivered into the chamber 110 by the base delivery system 150. For example, in an embodiment using the distribution-blending-cooling dish 120, the rate of delivery can be in consideration of the available surface area of the distribution-blending-cooling dish 120. The operator may program manually or automatically into the base flow controller 162, or PC, or PLC the amount of base to be delivered, the rate of flow of the base, or both as may be appropriate in a particular situation.

The base delivery system 150 further includes a base spray nozzle(s) 166 for spraying the base into the chamber 110 in the distribution-blending area 222 or above the distribution-blending-cooling dish 120. Since the base pump 164 may vibrate and cause a pulsating delivery stream, the base delivery system 150 of the present invention allows a volume of air to pass through a vortex formed by the operation of the base peristaltic pump 164, and to an inlet of a head of the base peristaltic pump 164. The air forms a cushion, which may dampen the pulsation in the delivery stream. By controlling the volume of air allowed into the vortex, the non-soluble particle suspension may be regulated to allow substantially uniform suspension of solids and delivery of the base into the chamber 110.

The second powder in the machine employs the unique feature of a Powder 1 delivery system. The unique feature of a Powder 1 (e.g. calcium sulfate) delivery system includes the use of a water conveyor. Water is metered into a dispensing chamber via nozzles that are positioned to counteract the gravitational swirl (counter-clockwise rotation in the Northern hemisphere) and prevents a vortex from forming. Instead, the motion of the water in the chamber is back and forth, preventing the powder from collecting on the sides of the chamber. In this case, one delivers Powder 1 to the mixing pump via a Ventura port at the inlet of the pump. It is important to note that although it is not necessary to the scope of the intended invention the nozzles for delivery are capable of turning or rotating about an 180° axis, thereby creating a vortex and enhancing a counter-clockwise swirl. The powder can be delivered into the vortex in a manner whereas no air is allowed to the pump head. Such is achieved by a variety of mechanisms including flexible nozzles, bendable nozzles, rotating nozzles and accordion like structured nozzles, for example. The positions of injectors in the main mixing tank are such to enhance the counter-clockwise rotation thereby forcing the solution to the cooling wall and allowing for a well mixed solution but disallows a vortex at the tank outlet.

The existing slurry system for a Powder 2 (e.g. calcium hydroxide) system embodiment has several unique features. Both the slurry mixing and delivery systems use peristaltic pumps that vibrate and cause unfavorable pulsating delivery streams. One example of a discovery is to allow a certain volume of air to pass through the vortex and to the inlet of a peristaltic pump head. In doing so, the inherent pulsation is dampened by an air cushion. For the application of acidic solution of sparingly-soluble Group IIA complexes (“AGIIS”) one can control the amount of air allowed into the vortex that greatly enhances the non-soluble particle suspension, thereby providing a uniform delivery of the base element that compliment the mathematically calculated volumes as mentioned above (see, U.S. patent application Ser. No. 09/500,473, “Acidic Solution of Sparingly-Soluble Group IIA Complexes”, filed Feb. 9, 2000, the entire content of which is hereby incorporated by reference). Briefly, the 09/500,473 application involves an acidic solution of sparingly-soluble Group IIA complexes (“AGIIS”), its preparation and its uses. The AGIIS can be prepared by mixing a mineral acid (such as sulfuric acid), and a Group IIA hydroxide (such as calcium hydroxide) or a Group IIA salt of a dibasic acid (such as calcium sulfate), or a mixture of the two Group IIA compounds, followed by removing the solid formed. The various uses include cleaning, food production, decontamination, bioremediation, agricultural application, medical application, and detoxification of substances.

An embodiment of the apparatus 100 may also optionally include a chamber lid or cover that can be dome shaped. The lid includes a vent at the top, wherein ambient air outside the mixing tank can pass through the lid via a torturous path and into the chamber 110. The torturous path prevents liquid from escaping from the mixing vessel during mixing and/or wash down cycles. As heat in generated by the ionic exchange at the introduction point, (e.g. spray nozzles and flooded dish) the chimney effect will carry hot air up from the chamber 110, through bottom discharge holes in the lid and out of the dish cover vent. Although not wanting to be bound by theory, the chimney effect suggests that the more heat dissipated in the air the better and faster the process works. An exhaust fan 500 can assist airflow. This feature makes the process temperature more manageable and is significant when higher normality solutions are manufactured. Thus, specific process temperatures might stabilize a process and cause a positive affect in the solution.

The apparatus 100 further comprises a precipitate chamber 170 connected to the chamber 110 wherein the mixture is allowed to settle and precipitate. The apparatus 100 further includes a filter chamber 172 connected to the precipitate chamber 170 wherein the mixture is filtered, such as by use of high pressure cross membrane filtration. Solids can be removed with use of a centrifuge. These are solids that cannot be broken down in the mixing operation and are different from those mentioned above concerning the shearing of bonded particles. The apparatus 100 further comprises a storage chamber 174 connected to the filter chamber 172 wherein the filtered mixture can be stored.

An embodiment of the invention envisions the product delivery to the precipitate chamber 170 that comprises a control by valve 302. During delivery, valve 302 is opened and sensor 304 senses the flow of product when sensor 304 detects a low material flow condition on air purge valve 306 is enabled that purges the transfer line 308 with air to force the remaining product into the precipitate chamber 170.

The apparatus 100 operates as follows: The acid, which may, in one embodiment, be sulfuric acid, is stored in liquid form in the acid reservoir 132. The acid flow controller 138 employs the acid flow valve 134 and the acid flow meter 136 to regulate the amount of acid to be delivered into the chamber 110. In the illustrated embodiment, the acid is introduced into the chamber 110 under water and near the bottom of the chamber 110. It is then a predetermined diluted acid of which then is first introduced to the base, in mid air above the distribution-blending-cooling dish 120. A water delivery system (not shown) delivers water into the chamber 110. A predetermined amount of acid is diluted with a predetermined amount of water to give a diluted acid, which then; a measured and controlled portion is pumped by the mixing pump 140 out of the chamber 110 and diverted to the diluted acid spray nozzle 142 into the chamber 110 via the distribution-blending dish 120. The remaining portion of diluted acid being pumped by the mixing pump 140 is diverted to the eductor or injector. Ports strategically placed around the chamber 110 as described above.

In a specific embodiment, calcium hydroxide is stored in dry powder form and made into a slurry form in the base reservoir 152. Calcium hydroxide is available in solid form as a powder. The calcium hydroxide may be combined with water to form a calcium hydroxide slurry having a predetermined concentration. The base flow controller 162 employs the base flow valve 158 and the base flow meter 160 to regulate the amount of base delivered into the chamber 110. The base (e.g. a calcium hydroxide slurry) is sprayed via the base spray nozzle 166 into the chamber 110 above the distribution-blending-cooling dish 120.

The acid and the base are sprayed into the air above the distribution-blending dish 120, where the initial blending takes place, to yield a first mixture. Blending in mid air by spray enhances the mixing by creating a favorable environment wherein the chemical/electrical exchange can occur with little constraint. Thus, the apparatus 100 of the current invention is able to blend the acid and the base(s) with less encapsulation of the hydroxide than was possible in prior art.

Further, by controlling the rates of flow of the acid and the base, and by using predetermined and mathematically calculated amounts (volumes) of the acid and the base, the exothermic conditions are more predictable and are more manageable. For example, much of the heat from each mid air exchange may be dissipated into the ambient air proximate a location of the mid air exchange. By reducing the heat, the blending or mixing becomes more controllable, thereby producing a more consistent mixture.

The first mixture, any encapsulated hydroxide, and any un-reacted acid and base are collected on the distribution-blending-cooling dish 120. The size and shape of the distribution-blending-cooling dish 120 with bath nozzles as shown allows only a thin layer to collect on the distribution-blending-cooling dish 120 surface. The acid/base mixture can be progressively blended in a thin film on the distribution-blending-cooling dish 120 to give a second mixture. The combination of the thin film blending and the cool dish serves to remove a portion of the heat prior to the next progressive stage of blending of the acid and the base that occurs in chamber 110.

In the illustrated embodiment, the distribution-blending-cooling dish 120 has an aperture therein to allow the second mixture and any un-reacted acid and base to fall there through to be collected, cooled, mixed in chamber 110 and re-circulated to the dish 120 or other dishes as many times as desired. Progressive mixture in situ within the chamber 110 below the distribution-blending-cooling dish 120. The mixing pump 140 may then be employed to pump the progressive mixture, any encapsulated hydroxide, and any un-reacted acid and base out of the chamber 110, to be sprayed back into the chamber 110 above the distribution-blending-cooling dish 120. Additionally, the pump 140 may crush any encapsulated hydroxide or un-reacted base to allow a more complete reaction to occur while causing a more favorable utilization of raw material.

The continuous blending in the air above the distribution-blending-cooling dish 120, and then in the thin film on the distribution-blending-cooling dish 120 and in situ within the chamber 110 below the distribution-blending-cooling dish 120 advantageously provides an exothermically generated mixture not previously possible using prior art reaction vessels and processes. Additionally, the end result of the mixture is more predictable.

In another embodiment, the acid and base are introduced into the distribution-blending area 222 via the acid delivery system 130 and base delivery system 150, respectively. Following the acid/base mixing in the distribution-blending area 222, the acid/base mix is re-circulated by a high shear force pump 140. In this embodiment, pump 140 is adapted to apply a high shear force to the acid/base mix as it is pumped back to the acid spray for further mixing in the chamber 110. The shear force will breaks-up most of the encapsulated material from a previous mixing of the acid and base reaction, which assures more efficient mixing. A batch mix can be re-circulated many times to ensure a more uniform final product.

Operation of the invention apparatus 100 can also include a wash cycle to rinse the mixing equipment and transfer lines that water and/or cleaning solutions are introduced into the chamber 110. Pump 140 is enabled during the wash cycle and is disabled when flow sensor 304 detects a low flow condition. Subsequently, air purge valve 306 is enabled for air purging of the transfer line 308.

The operation of the apparatus 100 can also be described as a process managed by software executed in the PC 190. The PC 190 is coupled to the valves, flow sensors, flow controllers, pumps, meters, cooling coils, etc., necessary to manage the process, however, the coupling lines are omitted for clarity. As an example, for the water charge, water amounts and flow rates for the chamber 110 are input to the computer 190. The computer 190 then opens valve 182 to the chamber 110 and monitors the flow (184, 186) until the input value is reached and subsequently closes the valve 182. The computer 190 subsequently activates the mix pump 140 and then begins the acid charge. The acid charge amount and flow rate are input to the computer 190, which then enables the acid flow to begin into the chamber 110. The acid valve 134 is opened and the acid pump 131 is initiated. The acid flow is monitored (136,138) until the input value is reached and the flow valve is then closed.

For the slurry operation, a predetermined water charge amount and flow rate for the base reservoir are input to the computer 190. The computer 190 then enables water transfer to the base reservoir through valve 192, flow meter 194 and flow controller 196. Water flow is stopped when the predetermined quantity is attained. Next, the system 200 is activated to deliver a predetermined amount of base to the base reservoir 152. The base and water are mixed and re-circulated by pump 155 that may be computer controlled. Additionally, the temperature can be cooperative controlled by a computer. The slurry is delivered to the chamber 110 when the computer 190 opens valve 158 to the chamber 110. The computer also activates the delivery pump 164 and monitors/regulates the flow by cooperative use of flow meter 160 and flow controller 162. When a low flow condition is monitored from the flow meter 160 by the computer 190, the re-circulation pump 155 and delivery pump 164 are deactivated. Additionally, a low flow condition will cause the computer 190 to close the valve 158.

Following mixing of the acid and base the computer 190 begins a sequence for product delivery. Initially, valve 302 is opened to begin product flow. However, when a low product flow condition is determined via the flow meter 304, the mixing pump 140 is deactivated, and valve 302 is closed. The computer 190 then activates an air purge of the transfer line 308 via air purge valve 306. Following air purge, product delivery is complete and ready for precipitating and filtering.

Although the present invention has been described in detail, those skilled in the art should understand that they could make various changes, substitutions and alterations herein without departing from the spirit and scope of the invention in its broadest form.

What is claimed is:

1. An apparatus for blending an acid and a base to form a mixture, comprising:
(a) a chamber;
(b) a distribution-blending-cooling dish suspended therein;
(c) an acid delivery system for introducing the acid into the chamber and to the distribution-blending-cooling dish; and
(d) a base delivery system for introducing the base into the chamber via the distribution-blending-cooling dish;
wherein the acid and the base are mixed within a thin layer on the distribution-blending-cooling dish, and then in situ mixing occurs within the chamber below the distribution-blending-cooling dish.

2. The apparatus of claim 1, wherein the acid comprises sulfuric acid.

3. The apparatus of claim 1, wherein the acid is diluted in water.

4. The apparatus of claim 1, wherein the base comprises calcium hydroxide.

5. The apparatus of claim 1, wherein the base is mixed in water to form a slurry.

6. The apparatus of claim 1, wherein an inside surface of the chamber comprises a non-corrosive coating.

7. The apparatus of claim 6, wherein the corrosive coating comprises a derivative of fluro polymers.

8. The apparatus of claim 6, wherein the non-corrosive coating comprises ethyl tetraflouro ethylene.

9. The apparatus of claim 1, further comprising a chamber cooling coil coupled to the chamber to lower temperature of the chamber.

10. The apparatus of claim 9, further comprising a chamber temperature sensor, coupled to the chamber, the chamber temperature sensor sensing temperature of the chamber, and the chamber cooling coil cooperating with the chamber temperature sensor to regulate the temperature.

11. The apparatus of claim 1, further comprising a dish cooling coil coupled to the distribution-blending-cooling dish, to lower temperature of the distribution-blending-cooling dish.

12. The apparatus of claim 11, further comprising a dish temperature sensor, coupled to the distribution-blending-cooling dish, wherein the dish temperature sensor senses the temperature of the distribution-blending dish and the dish cooling coil cooperating with the dish temperature sensor to regulate the temperature of the distribution-blending-cooling.

13. The apparatus of claim 1, wherein the distribution-blending-cooling dish is of an adequate size and shape to allow broad distribution of the acid and the base components, and wherein cooling of the mixture occurs.

14. The apparatus of claim 1, wherein the distribution-blending-cooling dish is of a minimal depth and shape to allow broad distribution of the acid and the base components, and wherein cooling of the mixture occurs.

15. The apparatus of claim 1, wherein the distribution-blending-cooling dish comprises a non-corrosive coating.

16. The apparatus of claim 15, wherein the non-corrosive coating comprises a derivative of fluro polymers.

17. The apparatus of claim 15, wherein the non-corrosive coating comprises ethyl tetraflouro ethylene.

18. The apparatus of claim 1, wherein the acid delivery system comprises a spray mechanism.

19. The apparatus of claim 1, wherein the acid delivery system comprises in-air mixing.

20. The apparatus of claim 19, wherein the in-air mixing diminishes the mixture from adhering to an inside wall of the chamber in large amounts.

21. The apparatus of claim 19, wherein the in-air mixing diminishes the mixture from generating hard particles.

22. The apparatus of claim 21, wherein the hard particles comprise un-reacted base.

23. The apparatus of claim 21, wherein the hard particles comprise encapsulated hydroxide.

24. The apparatus of claim 1, wherein the base delivery system comprises a spray mechanism.

25. The apparatus of claim 1, wherein the base delivery system comprises in-air mixing.

26. The apparatus of claim 25, wherein the in-air mixing diminishes the mixture from adhering to an inside wall of the chamber in large amounts.

27. The apparatus of claim 25, wherein the in-air mixing diminishes the mixture from generating hard particles.

28. The apparatus of claim 27, wherein the hard particles comprise encapsulated hydroxide.

29. The apparatus of claim 27, wherein the hard particles comprise un-reacted base.

30. The apparatus of claim 1, wherein a slurry is formed with the base to promote base delivery.

31. The apparatus of claim 1, wherein the acid delivery system comprises:
(a) an acid pump; and
(b) an acid delivery nozzle, wherein the acid pump and the acid delivery nozzle are coupled thereto to introduce the acid into the chamber.

32. The apparatus of claim 1, wherein the acid delivery system comprises an acid reservoir.

33. The apparatus of claim 32, further comprising an acid reservoir cooling coil coupled to the acid reservoir, wherein the cooling coil operates to lower a temperature of the acid reservoir.

34. The apparatus of claim 1, wherein the acid delivery system comprises a device to regulate a rate of flow of the acid.

35. The apparatus of claim 34, wherein the device to regulate the rate of flow of the acid comprises an acid flow valve.

36. The apparatus of claim 34, wherein the device to regulate the rate of flow of the acid comprises an acid flow meter, and an acid flow valve, wherein the acid flow meter is coupled to the acid flow valve and reflects the flow of the acid.

37. The apparatus of claim 34, wherein the device comprises an acid flow controller that monitors an acid flow meter and adjusts an acid flow valve to maintain a rate of flow for the acid at a predetermined level.

38. The apparatus of claim 37, wherein the predetermined level comprises a programmable function of the acid flow controller.

39. The apparatus of claim 1, wherein the acid delivery system is capable of regulating an amount of the acid delivered into the chamber.

40. The apparatus of claim 1, wherein the acid delivery system introduces the acid into the chamber at different points within the chamber.

41. The apparatus of claim 41, wherein different points within the chamber comprise points below the distribution-blending-cooling dish, wherein the acid is diluted with water to give a diluted acid.

42. The apparatus of claim 1, wherein the acid delivery system comprises a vortex generator to generate a vortex of the acid.

43. The apparatus of claim 42, wherein the vortex generator comprises:
(a) a plurality of circulation eductors inside the chamber; and
(b) a pump, in fluid communication with the plurality of circulation eductors;
whereby the pump circulates the dilute acid through the plurality of eductors to initiate a movement of the dilute acid in a rotational direction to create a vortex.

44. The apparatus of claim 43, wherein the plurality of eductors are strategically placed inside the chamber at different elevations.

45. The apparatus of claim 43, wherein the direction of the plurality of eductors within the chamber exerts control over the rotational speed of the dilute acid and control over the size of the vortex.

46. The apparatus of claim 43, wherein the rotational speed of the dilute acid, and size of the vortex can maximize the thermal exchange of the acid with the wall of the chamber.

47. The apparatus of claim 43, wherein the acid and the base are mixed within a thin layer on the distribution-blending-cooling dish to form a suspension that contains hard particles of an un-reacted base, wherein the pump crushes the hard particle of the un-reacted base, and the acid delivery system delivers the un-reacted base or suspension thereof into the chamber via the distribution-blending-cooling dish.

48. The apparatus of claim 43, wherein the vortex enhances the in situ mixing within the chamber below the distribution-blending-cooling dish.

49. The apparatus of claim 1, wherein the base delivery system comprises:
(a) a base pump; and
(b) a base delivery nozzle, wherein the base pump and the base delivery nozzle are coupled thereto to introduce the base into the chamber.

50. The apparatus of claim 1, wherein the base delivery system comprises a base reservoir that contains the base.

51. The apparatus of claim 50, wherein the base delivery system further comprises a base reservoir cooling coil coupled to the base reservoir to lower temperature of the base reservoir.

52. The apparatus of claim 51, further comprising a base reservoir temperature sensor, coupled to the base reservoir; wherein the base reservoir temperature sensor senses the temperature of the base reservoir and the base reservoir cooling coil cooperating with the base reservoir temperature sensor to regulate the temperature of the base reservoir.

53. The apparatus of claim 1, wherein the base delivery system comprises a device to regulate a rate of flow of the base.

54. The apparatus of claim 53, wherein the device to regulate the rate of flow of the base comprises an acid flow valve.

55. The apparatus of claim 53, wherein the device to regulate the rate of flow of the base comprises a base flow meter, and a base flow valve, wherein the base flow meter is coupled to the base flow valve and reflects the flow of the base.

56. The apparatus of claim 53, wherein the device comprises an base flow controller that monitors an base flow meter and adjusts a base flow valve to maintain a rate of flow for the base at a predetermined level.

57. The apparatus of claim 56, wherein the predetermined level is a programmable function of the base flow controller.

58. The apparatus of claim 1, wherein the base delivery system is capable of regulating an amount of the base delivered into the chamber.

59. The apparatus of claim 1, further comprising a precipitate chamber allowing the precipitation of solids.

60. The apparatus of claim 1, further comprising a filter chamber filtering the mixture.

61. The apparatus of claim 1, further comprising a storage chamber storing the mixture.

62. An apparatus for blending an acid and a base to form a mixture, comprising:
(a) a chamber;
(b) a distribution-blending-cooling dish suspended therein;
(c) an acid delivery system for spraying the acid into the chamber and to the distribution-blending-cooling dish, wherein the acid delivery system is capable of regulating a rate of flow and an amount of the acid sprayed into the chamber; and
(d) a base delivery system for spraying the base into the chamber via the distribution-blending-cooling dish, wherein the base delivery system is capable of regulating a rate of flow and an amount of the base sprayed into the chamber;
wherein blending of the acid and the base comprises in-air mixing above the distribution-blending-cooling dish and proximate the acid delivery systems, progressive mixing continues within a thin layer on the surface of the distribution-blending-cooling dish, and in situ mixing occurs within the chamber below the distribution-blending-cooling dish.

63. The apparatus of claim 62, wherein the acid comprises sulfuric acid.

64. The apparatus of claim 62, wherein the acid is diluted in water.

65. The apparatus of claim 62, wherein the base comprises calcium hydroxide.

66. The apparatus of claim 62, wherein the base is mixed in water to form a slurry.

67. The apparatus of claim 62, wherein an inside surface of the chamber comprises of a non-corrosive coating.

68. The apparatus of claim 67, wherein the non-corrosive coating comprises a derivative of fluro polyerms.

69. The apparatus of claim 67, wherein non-corrosive coating comprises ethyl tetraflouro ethylene.

70. The apparatus of claim 62, further comprising a chamber cooling coil coupled to the chamber to lower temperature of the chamber.

71. The apparatus of claim 70, further comprising a chamber temperature sensor, coupled to the chamber, the chamber temperature sensor sensing temperature of the chamber, and the chamber cooling coil cooperating with the chamber temperature sensor to regulate the temperature.

72. The apparatus of claim 62, further comprising a dish cooling coil coupled to the distribution-blending-cooling dish to lower temperature of the distribution-blending-cooling dish.

73. The apparatus of claim 72, further comprising a dish temperature sensor, coupled to the distribution-blending-cooling dish, wherein the dish temperature sensor senses the temperature of the distribution-blending dish, and the dish cooling coil cooperating with the dish temperature sensor to regulate the temperature of the distribution-blending-cooling dish.

74. The apparatus of claim 62, wherein the distribution-blending-cooling dish comprises an adequate size and shape to allow broad distribution of the acid and the base components, and wherein cooling of the mixture occurs.

75. The apparatus of claim 62, wherein the distribution-blending-cooling dish comprises a minimal depth and shape to allow broad distribution of the acid and the base components, and wherein cooling of the mixture occurs.

76. The apparatus of claim 62, wherein the distribution-blending-cooling dish comprises a non-corrosive coating.

77. The apparatus of claim 76, wherein the non-corrosive coating comprises a derivative of fluro plymers.

78. The apparatus of claim 76, wherein non-corrosive coating comprises ethyl tetraflouro ethylene.

79. The apparatus of claim 62, wherein the acid delivery system comprises:
(a) an acid reservoir;
(b) an acid flow valve; and
(c) an acid flow meter;
wherein the acid reservoir that contains the acid is coupled to the acid flow valve that controls rate of flow of the acid, and is coupled to the acid flow meter that measures the flow of the acid.

80. The apparatus of claim 79, further comprising an acid reservoir cooling coil coupled to the acid reservoir to lower a temperature of the acid reservoir.

81. The apparatus of claim 79, wherein the acid flow meter is coupled to the acid flow valve and reflects the flow of the acid, wherein an acid flow controller monitors the acid flow meter, and the acid flow controller is capable of adjusting the acid flow valve to maintain a rate of flow for the acid at a predetermined level.

82. The apparatus of claim 81, wherein the predetermined level is a programmable function of the acid flow controller.

83. The apparatus of claim 62, wherein the acid delivery system is capable of regulating an amount of the acid delivered into the chamber.

84. The apparatus of claim 62, wherein the acid delivery system introduces the acid into the chamber at different points within the chamber.

85. The apparatus of claim 84, wherein different points within the chamber comprise points below the distribution-blending-cooling dish, wherein the acid is diluted with water to give a diluted acid.

86. The apparatus of claim 62, wherein the vortex generator comprises:
(a) a plurality of circulation eductor inside the chamber; and
(b) a pump, in fluid communication with the circulation injectors;
whereby the pump circulates the dilute acid through the plurality of injectors to initiate a movement of the dilute acid in a rotational direction to create a vortex.

87. The apparatus of claim 86, wherein the plurality of injectors are strategically placed inside the chamber at different elevations.

88. The apparatus of claim 86, wherein the direction of the plurality of injectors within the chamber exerts control over the rotational speed of the dilute acid and control over the size of the vortex.

89. The apparatus of claim 86, wherein the rotational speed of the dilute acid, and size of the vortex can maximize the thermal exchange of the acid with the wall of the chamber.

90. The apparatus of claim 86, wherein the acid and the base are mixed within a thin layer on the distribution-blending-cooling dish to form a suspension that contains hard particles of an un-reacted base, wherein the pump crushes the hard particle of the un-reacted base, and the acid delivery system delivers the un-reacted base or suspension thereof into the chamber via the distribution-blending-cooling dish.

91. The apparatus of claim 86 wherein the pump is a peristaltic pump.

92. The apparatus of claim 86, wherein the vortex enhances the in situ mixing within the chamber below the distribution-blending-cooling dish.

93. The apparatus of claim 62, wherein the base delivery system comprises:
(a) a base reservoir;
(b) a base flow valve; and
(c) a base flow meter;
wherein the base reservoir that contains the base is coupled to the base flow valve that controls rate of flow of the base, and is coupled to the base flow meter that measures the flow of the base.

94. The apparatus of claim 94, further comprising a base reservoir cooling coil coupled to the base reservoir to lower temperature of the base reservoir.

95. The apparatus of claim 79, wherein the base flow meter is coupled to the base flow valve and reflects the flow of the base, wherein a base flow controller monitors the acid flow meter and the base flow controller is capable of adjusting the base flow valve to maintain a rate of flow for the base at a predetermined level.

96. The apparatus of claim 96, wherein the predetermined level is a programmable function of the base flow controller.

97. The apparatus of claim 62, further comprising a precipitate chamber allowing the precipitation of solid particles.

98. The apparatus of claim 62, further comprising a filter chamber filtering the mixture.

99. The apparatus of claim 62, further comprising a storage chamber storing the mixture.
